(19) United States
(12) Patent Application Publication
(10) Pub. No.: US 2006/0240306 A1
(43) Pub. Date: Oct. 26, 2006

(54) Stable, inexpensive, and freeze capable gasket for PEM fuel cells

(76) Inventors: Youssef M. Mikhail, Sterling Heights, MI (US); Mahmoud H. Abd Elhamid, Grosse Pointe Woods, MI (US); Richard H. Blunk, Macomb Township, MI (US); Michael K. Budinski, Pittsford, NY (US); Vinod Kumar, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/112,220

(22) Filed: Apr. 22, 2005

(51) Int. Cl. H01M 2/08; H01M 8/02; H01M 8/12; H01M 8/10; F16J 15/10

(52) U.S. Cl. 429/35; 429/30; 428/408; 277/650

(57) ABSTRACT

A gasket formed of compressed graphite that is resistant to, damage, freezing, and high temperatures. The gasket provides advantages in fuel cells.

### FIELD OF THE INVENTION

The present invention relates to a gasket or seal for a fuel cell.

### BACKGROUND OF THE INVENTION

Fuel cells are increasingly being pursued as a power source for automobiles and other applications. One such fuel cell is a Proton Exchange Membrane (“PEM”) fuel cell that includes membrane-electrode-assembly (“MEA”) comprising a thin, solid polymer membrane-electrolyte having a pair of electrodes (i.e., an anode and a cathode) on opposite faces of the membrane-electrolyte. The MEA is sandwiched between planar gas distribution elements.

The electrodes are typically of a smaller surface area as compared to the membrane electrolyte such that edges of the membrane electrolyte protrude outward from the electrodes. On these edges of the membrane electrolyte, gaskets or seals are disposed to peripherally frame the electrodes. These gaskets or seals, however, are susceptible to shrinkage and expansion during changes in temperature that can cause cracks and leaks in the gaskets or seals. As such, these gaskets or seals can degrade the performance of the fuel cell over time. Accordingly, it is desirable to develop a gasket or seal that is resistant to expansion and contraction during the life of a fuel cell.

### SUMMARY OF THE INVENTION

The present invention provides a gasket formed of compressed graphite that is resistant to expansion and contraction at both freezing and high temperatures. The present invention further provides an MEA containing the gasket, and a fuel cell containing the MEA.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded, cross-sectional view of a fuel cell including a gasket according to a principle of the present invention; and

FIG. 2 is a polarization curve obtained from a fuel cell utilizing a gasket according to a principle of the present invention.

### DETAILED DESCRIPTION OF THE PREFERRED EMBODIMENTS

The following description of the preferred embodiment(s) is merely exemplary in nature and is in no way intended to limit the invention, its application, or uses.

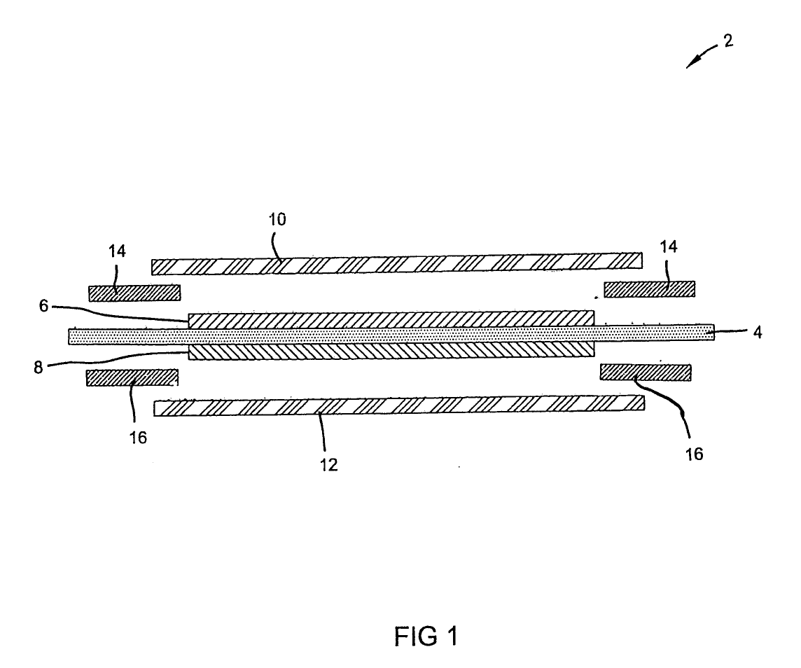

FIG. 1 is a cross-sectional view of a fuel cell including a gasket according to the present invention. As shown in FIG. 1, the fuel cell 2 includes an ionically conductive member 4 sandwiched by an anode 6 and a cathode 8 forming an MEA. The MEA is further sandwiched by a pair of electrically conductive gas diffusion media 10 and 12. The gas diffusion media 10 and 12 are peripherally surrounded by frame-shaped gaskets 14 and 16. The gaskets 14 and 16 and diffusion media 10 and 12 may or may not be laminated to the ionically conductive member 4 and/or the electrodes 6 and 8.

The ionically conductive member 4 is preferably a solid polymer membrane electrolyte, and preferably a PEM. Member 4 is also referred to herein as a membrane 4. Preferably, the ionically conductive member 4 has a thickness in the range of about 10 μm-100 μm, and most preferably a thickness of about 20-30 μm. Polymers suitable for such membrane electrolytes are well known in the art and are described in, fore example, U.S. Pat. Nos. 5,272,017 and 3,134,697 and elsewhere in the patent and non-patent literature. It should be noted that the composition of the ionically conductive member 4 may comprise any of the proton conductive polymers conventionally used in the art. Preferably, perfluorinated sulfonic acid polymers such as NAFION® (available from Dupont) are used.

The composition of the anode 6 and cathode 8 preferably comprises electrochemically active material dispersed in a polymer binder that, like the ionically conductive member 4, is a proton conductive material such as perfluorinated sulfonic acid polymer. The electrochemically active material preferably comprises catalyst-coated carbon or graphite particles. The anode 6 and cathode 8 preferably include platinum, platinum-ruthenium, or other Pt/transition metal alloys as the catalyst. Although the anode 6 and cathode 8 in the figures are shown to be equal in size, it should be noted that the anode 6 and cathode 8 may be of different size (e.g., the cathode larger than the anode or vice versa). A preferred thickness of the anode and cathode is in the range of about 2-30 μm, and most preferably about 8-12 μm.

With respect to the gas diffusion media 10 and 12, these electrically conductive members may be any gas diffusion media known in the art. Preferably, the gas diffusion media 10 and 12 are carbon papers, carbon cloths, or carbon foams with a thickness of in the range of about 50-300 μm.

The gaskets 14 and 16 are frame-shaped sealing members that peripherally surround the anode 6 and cathode 8. According to the present invention, the gaskets 14 and 16 are made of Grafoil®, a product of GRAFTech International Ltd, with a density of 1.5 g/cm³. Grafoil® is compressed graphite, which is an electrically conductive material that is relatively inexpensive, chemically resistant, and freeze-resistant. As such, compressed graphite is an ideal material for use gaskets 14 and 16 in a fuel cell 2. This is because, in comparison to a prior art gasket formed of a material such as a silicone, the gaskets 14 and 16 formed of compressed graphite resist developing pinholes or cracks during the lifespan of the fuel cell 2. In contrast, prior art gaskets, such as a silicone gaskets, are susceptible to chemical degradation as well as degradation due to being exposed to fluctuating temperatures.

More specifically, the fuel cell environment is typically acidic. During operation of the fuel cell 2, acidic byproducts are produced from materials such as sulfuric acid, hydrogen fluoride (HF), and peroxides. These acidicbyproducts may degrade the elements of the fuel cell 2, which, over the lifespan of the fuel cell 2, can cause failures such as pinholes or cracks to develop in gaskets 14 and 16. If such a failure develops, leaks such as reactant gas and coolant leaks can occur which degrade fuel cell performance and shorten its useful life. Silicone gaskets are particularly susceptible to these failures in environments containing HF.

The compressed graphite gaskets 14 and 16 according to the present invention, however, are stable in acidic environments. As such, the acidic byproducts provided by sulfuric acid, HF, and peroxide ions will not degrade the gaskets 14 and 16. The gaskets 14 and 16, therefore, will not develop failures such as pinholes during operation of the fuel cell 2.

Moreover, since the gaskets 14 and 16 formed of compressed graphite are not susceptible to acidic environments, it should be understood that the gaskets 14 and 16 can directly contact the membrane 4. In contrast, a prior art gasket formed of, for example, silicone cannot directly contact the membrane 4 because the membrane 4 is generally formed of NAFION® which is corrosive to the gaskets. As stated above, sulfuric acid ions contribute to the acidity of the fuel cell environment. Prior art silicone gaskets require the use of a sub-gasket to avoid contact with the membrane 4. Since the gaskets 14 and 16 of the present invention are formed of compressed graphite, however, the need for a sub-gasket is not required. The cost and manufacturing complexity of the fuel cell, therefore, can be reduced further.

When the gaskets 14 and 16 are in contact with the membrane 4, it may be desirable to utilize an adhesive to attach the gaskets 14 and 16 to the membrane. Any appropriate adhesive known to one skilled in the art may be utilized. An adhesive, however, is not required for the present invention. This is because the gaskets 14 and 16 may physically bond to the membrane 4.

As stated above, the gaskets 14 and 16 formed of compressed graphite are also resistant to deformation t low temperatures. This is an important aspect of the present invention because when the fuel cell 2 is used in, for example, an automotive application where the automobile is operated in temperatures below freezing (i.e., below 0° C.), failures in the gaskets 14 and 16 may occur when prior art gaskets are used. When the fuel cell 2 is subjected to temperatures that fluctuate from below freezing to above freezing, the elements of the fuel cell 2 may expand and contract. An expansion and contraction of the gasket is particularly troublesome to prior art gaskets formed of, for example, silicone.

More specifically, as the silicone gasket expands and contracts, pinholes and cracks may develop in the gasket. These pinholes and cracks in turn cause reactant gas and coolant leaks to develop which hinder performance of the fuel cell and reduce its life span. The compressed graphite gaskets 14 and 16 according to the present invention, however, are dimensionally stable at temperatures ranging from −240° C. to 3000° C. Although the compressed graphite gaskets 14 and 16 can withstand temperatures ranging from −240° C. to 3000° C., it is particularly preferable that the gaskets 14 and 16 withstand temperatures ranging from −60 C to 100 C. Since the compressed graphite gaskets 14 and 16 are resistant to contraction when subjected to temperatures below freezing (i.e., freeze-resistant) and resistant to expansion when subjected to temperatures above 25° C. (i.e., heat resistant), the gaskets will not develop pinholes or cracks that cause leaks during operation of the fuel cell 2. Thus the fuel cell of the invention is more robust and efficient than prior art fuel cells.

It should also be understood that the compressed graphite used to form the gaskets 14 and 16 according to the present invention is preferably a very “clean” graphite. That is, the compressed graphite is preferably 99.995% pure. Since the compressed graphite is “clean,” the gaskets 14 and 16 do not contain contaminates that may hinder the performance of the fuel cell 2. The avoidance of contaminates in a fuel cell is important because contaminates such as metals like iron and nickel can act as a catalyst that increases the degradation of the elements of the fuel cell 2. When the compressed graphite gaskets according to the present invention are 99.995% pure, however, these contaminates are avoided in the fuel cell and a longer lasting and more robust fuel cell 2 is obtained.

The frame-shaped gaskets 14 and 16 are preferably die cut from a sheet of compressed graphite. A preferable thickness of the gaskets 14 and 16 is between 5 and 20 mils (50-500 •m). It should be understood, however, that any suitable thickness of the gaskets 14 and 16 can be used, and a preferred thickness for a particular MEA will depend upon such factors as thickness of other elements of the fuel cell.

More specifically, the thickness of the gaskets 14 and 16 can be selected in accordance with the thickness of the other elements of the fuel cell 2. Preferably, the thickness of the gaskets 14 and 16 is chosen depending on the thickness of the gas diffusion media 10 and 12. That is, if a thicker gas diffusion medium 10 and 12 is used, it may be desirable to utilize thicker gaskets 14 and 16. In contrast, if a thinner gas diffusion medium is chosen, it may be desirable to utilize thinner gaskets 14 and 16. Notwithstanding, it should be understood that the gaskets 14 and 16 can be any thickness desired by one skilled in the art.

The membrane 4 preferably extends outward from the gaskets 14 and 16. Preferably, the membrane 4 should extend outward from the gaskets 14 and 16 at a distance of up to 2 mm. In this manner, the compressed graphite gaskets 14 and 16 will not contact each other. The compressible graphite gaskets 14 and 16 should not contact each other because, as stated above, the compressed graphite gaskets 14 and 16 are electrically conductive. If the gaskets 14 and 16 were in contact with each other, the two sides of the fuel cell 2, that is the anode 6 and cathode 8 sides of the fuel cell 2, would be in electrical contact with each other. Such an arrangement is not desirable.

Since the membrane 4 preferably extends outward from the gaskets 14 and 16, it may be desirable, in some instances, to include sub-gaskets 11 and 13. Although a sub-gasket 11 and 13 is not required for the present invention, the sub-gaskets 11 and 13 may be disposed between the membrane 4 and the gaskets 14 and 16. More specifically, the subgaskets 11 and 13 may rest on the outward edges of the membrane 4 that extend outward from the fuel cell 2. The gaskets 14 and 16 will rest upon the sub-gaskets 11 and 13. In this manner, the gaskets 14 and 16 are further prevented from being in electrical contact with one another.

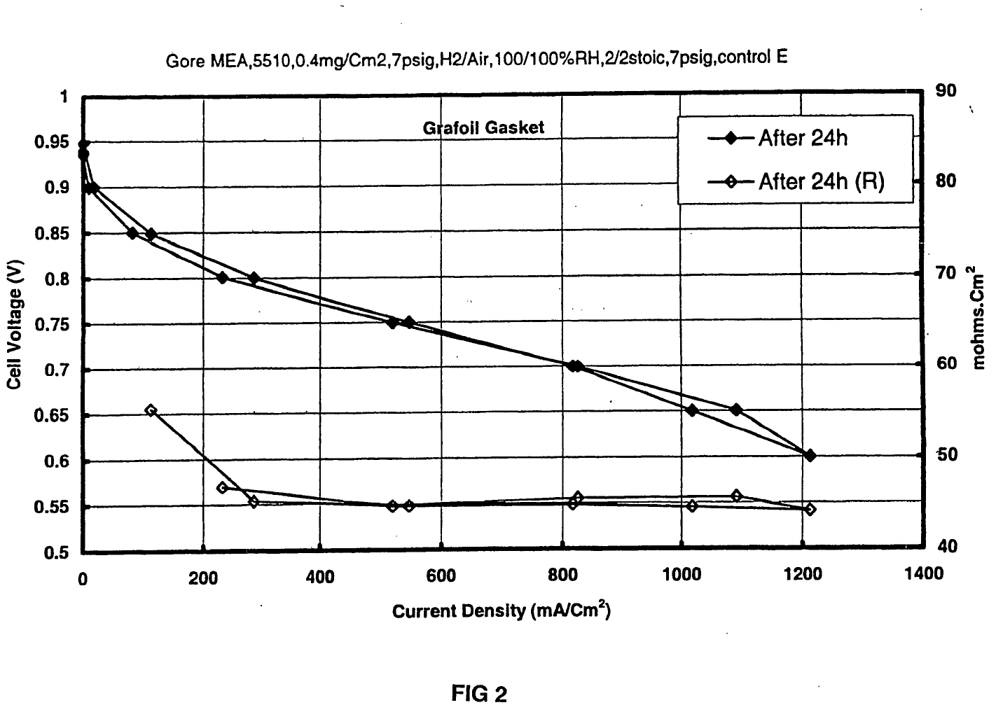

Referring to FIG. 2, it can be seen that a fuel cell utilizing a compressed graphite gaskets 14 and 16 achieves cell voltages, current densities, and resistances comparable to conventional gaskets formed of materials such as, for example, silicone.

In another aspect of the present invention, the compressed graphite gaskets 14 and 16 are anisotropic and lubricious. Compressed graphite has a natural lubricity that makes it an ideal choice for gaskets 14 and 16 in a fuel cell environment. This is because the gaskets 14 and 16 may be in direct contact with the anode 6 and cathode 8 and membrane 2. Since the anode 6, cathode 8, and membrane 4 are preferably formed of a NAFION®, the anode 6, cathode 8, and membrane 4 tend to swell during operation of the fuel cell 2 as a result of water being produced during the electrochemical reaction of the fuel cell. As the anode 6, cathode 8, and membrane 4 swell during operation of the fuel cell 2, they tend to creep as they expand and contract. Since the gaskets 14 and 16 formed of compressed graphite are naturally lubricious, however, the anode 6, cathode 8, and membrane 4 are free to move along a surface of the gaskets 14 and 16. This allows for a natural surface movement between the gaskets 14 and 16 and the soft elements of the fuel cell 2 avoiding undue stresses on the elements of the fuel cell 2 which can cause tearing or other failures to develop. Accordingly, the performance and efficiency of the fuel cell is further enhanced.

The gaskets 14 and 16 formed of compressed graphite also enable a fuel cell 2 to be compressed at higher pressures in a fuel cell stack. That is, the gaskets 14 and 16 enable a fuel cell stack to be compressed at pressures ranging from 50 to 400 psi. Preferably, however, the stack is compressed at pressures ranging form 100 to 300 psi. Most preferably, the stack is compressed at a pressure of 200 psi. Since the fuel cell 2 can be compressed to such pressures without damages to the gaskets 14 and 16, the durability of the fuel cell 2 is significantly enhanced.

Although the gaskets 14 and 16 according to the present invention have been described above with reference to a PEM fuel cell, it should be understood that the gaskets 14 and 16 can be used in any fuel cell known in the art. That is, the gaskets 14 and 16 can be used in an alkaline fuel cells and solid oxide fuel cells with similar advantages and not depart from the spirit and scope of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gasket for a fuel cell comprising compressed graphite.

2. The gasket according to claim 1, wherein the compressed graphite is electrically conductive.

3. The gasket according to claim 1, wherein the compressed graphite has a thickness in the range of about 6-20 mils.

4. The gasket according to claim 1, wherein the compressed graphite is resistant to temperatures in the range of −240° C. to 3000° C.

5. The gasket according to claim 1, wherein the compressed graphite is anisotropic.

6. The gasket according to claim 1, wherein the fuel cell is a proton exchange membrane fuel cell.

7. An alkaline fuel cell comprising a gasket according to claim 1.

8. A solid oxide fuel cell comprising a gasket according to claim 1.

9. A fuel cell comprising:
an ionically conductive membrane;
an electrode disposed at said membrane;
an electrically conductive member disposed at said electrode; and
a gasket disposed between said electrode and said electrically conductive member;
wherein said gasket comprises compressed graphite.

10. The fuel cell according to claim 9, wherein the electrically conductive member is a gas diffusion medium; and
a thickness of said gasket is selected in relation to a thickness of said gas diffusion medium.

11. The fuel cell according to claim 9, wherein said gasket is a frame-shaped member that peripherally surrounds said electrode.

12. The fuel cell according to claim 9, wherein said gasket rests on edges of said membrane.

13. The fuel cell according to claim 9, wherein said gasket allows said membrane and electrodes to move along a surface of said gasket upon swelling of said membrane and said electrodes.

14. The fuel cell according to claim 9, wherein said gasket enables said fuel cell to be compressed at pressures ranging from 50 to 400 psi.

15. A fuel cell stack comprising a plurality of the fuel cells according to claim 9.
